(19) United States
(12) Patent Application Publication
(10) Pub. No.: US 2022/0081737 A1
(43) Pub. Date: Mar. 17, 2022

(54) POND REACTOR FOR RECOVERY OF METALS

(71) Applicant: LIXIVIA, INC., Santa Barbara, CA (US)

(72) Inventor: Michael D Wyrsta, Santa Barbara, CA (US)

(21) Appl. No.: 17/414,180

(22) PCT Filed: Dec. 17, 2019
(86) PCT No.: PCT/US2019/066977

§ 371 Date: Jun. 15, 2021

Related U.S. Application Data
(60) Provisional application No. 62/781,453, filed on Dec. 18, 2018.

(51) Int. Cl. C22B 7/00; C22B 3/04

(52) U.S. Cl. CPC C22B 7/006; C22B 3/04

(57) ABSTRACT

The invention provides an inexpensive and scalable means to isolate commercially valuable metals from low quality raw materials with minimal capital expenditures. Metals are extracted from sized raw material using a lixiviant, such as an amine-based lixiviant, in a pond extractor. The liquid fraction containing solvated metal is separated from the extracted raw materials and exposed to an inexpensive and readily available source of carbon dioxide, such as unmodified atmospheric air and/or a flue gas. This precipitates the metal as a carbonate salt and regenerates the lixiviant, which is returned to the extraction step of the process following separation from the metal carbonates. Metal carbonates can be dried by simply arranging in exposed heaps, and in some embodiments further processed by kiln drying. Such methods can also be used to capture and sequester greenhouse gases such as carbon dioxide from the atmosphere.

This application claims the benefit of U.S. Provisional Application No. 62/781,453, filed on Dec. 18, 2018. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is recovery of metals from low quality ores, waste materials and/or, mine tailings, particularly with the use of a lixiviant.

### BACKGROUND

The following description includes information that may be useful in understanding the present invention. It is not an admission that any of the information provided herein is prior art or relevant to the presently claimed invention, or that any publication specifically or implicitly referenced is prior art.

There is a long-standing need to efficiently and cost-effectively recover commercially valuable metals from low yield sources, such as mine tailings.

Historically, it has been especially desirable to recover alkaline earth elements. Alkaline earth elements, also known as beryllium group elements, include beryllium (Be), magnesium (Mg), calcium (Ca), strontium (Sr), barium (Ba) and radium, (Ra), which range widely in abundance. Applications of these commercially important metals also vary widely, and include uses as dopants in electronic components, structural materials, and in the production foods and pharmaceuticals.

Methods of isolating of one member of the alkaline earth family, calcium, from minerals such as limestone, have been known since ancient times. In a typical process limestone is calcined or otherwise roasted to produce calcium oxide (CaO), or quicklime. This material can be reacted with water to produce calcium hydroxide (Ca(OH)₂), or slaked lime. Calcium hydroxide, in turn, can be suspended in water and reacted with dissolved carbon dioxide (CO₂) to form calcium carbonate (CaCO₃), which has a variety of uses. Approaches that have been used to isolate other members of this family of elements often involve the production of insoluble hydroxides and oxides using elevated temperatures or strong acids. Such approaches, however, are not suitable for many sources of alkaline earth elements (such as steel slag), and are not sufficiently selective to be readily applied to mixtures of alkaline earth elements.

Hydrometallurgy can also been used to isolate metals from a variety of minerals, ores, and other sources. Typically, ore is crushed and pulverized to increase the surface area prior to exposure to the solution (also known as a lixiviant). Suitable lixiviants solubilize the desired metal, and leave behind undesirable contaminants. Following collection of the lixiviant, the metal can be recovered from the solution by various means, such as by electrodeposition or by precipitation from the solution.

Previously known methods of hydrometallurgy have several problems. Identification of lixiviants that provide efficient and selective extraction of the desired metal or metals has been a significant technical barrier to their adoption in the isolation of some metals. Similarly, the expense of lixiviant components, and difficulties in adapting such techniques to current production plants, has limited their use.

Approaches have been devised to address these issues. U.S. Patent Application No. 2004/0228783 (to Harris, Lakshmanan, and Sridhar) describes the use of magnesium salts (in addition to hydrochloric acid) as a component of a highly acidic lixiviant used for recovery of other metals from their oxides, with recovery of magnesium oxide from the spent lixiviant by treatment with peroxide. Such highly acidic and oxidative conditions, however, present numerous production and potential environmental hazards that limit their utility. In an approach disclosed in U.S. Pat. No. 5,939,034 (to Virnig and Michael), metals are solubilized in an ammoniacal thiosulfate solution and extracted into an immiscible organic phase containing guanidyl or quaternary amine compounds. Metals are then recovered from the organic phase by electroplating.

A similar approach is disclosed in U.S. Pat. No. 6,951,960 (to Perraud) in which metals are extracted from an aqueous phase into an organic phase that contains an amine chloride. The organic phase is then contacted with a chloride-free aqueous phase that extracts metal chlorides from the organic phase. Amines are then regenerated in the organic phase by exposure to aqueous hydrochloric acid. Application to alkaline earth elements (for example, calcium) is not clear, however, and the disclosed methods necessarily involve the use of expensive and potentially toxic organic solvents.

In a related approach, European Patent Application No. EP1309392 (to Kocherginsky and Grischenko) discloses a membrane-based method in which copper is initially complexed with ammonia or organic amines. The copper:ammonia complexes are captured in an organic phase contained within the pores of a porous membrane, and the copper is transferred to an extracting agent held on the opposing side of the membrane. Such an approach, however, requires the use of complex equipment, and processing capacity is necessarily limited by the available surface area of the membrane.

Methods for capturing CO2 could be used to recover alkaline earth metals, but to date no one has appreciated that such could be done. Kodama et al. (Energy 33(2008), 776-784) discloses a method for CO2 capture using a calcium silicate (2CaO.SiO2) in association with ammonium chloride (NH4Cl). This reaction forms soluble calcium chloride (CaCl2), which is reacted with carbon dioxide (CO2) under alkaline conditions to form insoluble calcium carbonate (CaCO3) and release chloride ions (Cl−).

Kodama et al. uses clean forms of calcium to capture CO2, but is silent in regard to the use of other alkaline earth elements in this chemistry. This is consistent with Kodoma et al.'s disclosure of the loss of a high percentage (approximately 20%) of the NH4Cl by the disclosed process, requiring the use of additional equipment to capture ammonia vapor. In addition, Kodama appears to require the use of a dedicated source of high grade carbon dioxide. These characteristics result in significant process inefficiencies and cost requirements, and raise significant environmental concerns. Japanese Patent Application No. 2005097072 (to Katsunori and Tateaki) discloses a similar method for CO₂ capture, in which ammonium chloride (NH4Cl) is dissociated into ammonia gas (NH₃) and hydrochloric acid (HCl), the HCl being utilized to generate calcium chloride (CaCl₂) that is mixed with ammonium hydroxide (NH₄OH) for CO₂ capture, but similarly appears to require the use of high grade carbon dioxide.

International Application WO 2012/055750 (to Tavakkoli et al) discloses a method for purifying calcium carbonate (CaCO₃), in which impure CaCO3 is converted to impure calcium oxide (CaO) by calcination. The resulting CaO is treated with ammonium chloride (NH₄Cl) to produce calcium chloride (CaCl₂), which is subsequently reacted with high purity carbon dioxide (CO₂) to produce CaCO₃ and NH₄Cl, with CaCO₃ being removed from the solution by crystallization with the aid of seed crystals. Without means for capturing or containing the ammonia gas that would result from such a process, however, it is not clear if the disclosed method can be adapted to an industrial scale.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for a hydrometallurgical method that provides simple and economical isolation of metal hydroxide forming species.

### SUMMARY OF THE INVENTION

Systems, methods, and compositions are described that provide for recovery of valuable metals from crude raw materials, using simple open ponds as reactors. Raw materials containing insoluble salts and/or oxides of a desired metal are introduced to a pond reactor and contacted with a lixiviant that selectively solubilizes the desired metal. The desired metal is then precipitated as an insoluble or relatively insoluble carbonate following contact of the extracted metal with a source of CO₂, preferably untreated/atmospheric air. This reaction also regenerates the lixiviant compound, which can be recycled back into the process. The insoluble carbonate, which is of high purity, is collected and dried. In some embodiments the insoluble carbonate can be processed in a kiln to generate a high purity oxide of the metal of interest.

One embodiment of the inventive concept is a method of isolating a metal by contacting a raw material that includes the metal with a lixiviant in a first reactor to form a soluble metal salt and an extracted raw material (e.g. over a period of from 1 day to 3 months), separating the soluble metal salt from the extracted raw material, contacting the soluble metal salt with a source of carbon dioxide in a second reactor to form an insoluble metal carbonate and a regenerated lixiviant (e.g. over a period of from 1 day to 3 months), separating the insoluble metal carbonate from the regenerated lixiviant (e.g. by settling, filtration, and/or centrifugal separation), returning at least some of the regenerated lixiviant to the first reactor, and collecting the insoluble metal carbonate. In such methods unmodified air is the primary source of carbon dioxide utilized in formation of the insoluble metal carbonate. Either or both of the first reactor and/or the second reactor can be a pond reactor. In some embodiments at least a portion of separation of the soluble metal salt from the extracted raw material occurs prior to completion of formation of the soluble metal salt. Similarly, in some embodiments at least a portion of separation of the insoluble metal carbonate from the regenerated lixiviant occurs prior to completion of formation of the insoluble metal carbonate.

The lixiviant can be present in stoichiometric quantities, substoichiometric quantities, or superstoichiometric quantities relative to the metal content of the raw material.

In some embodiments the raw material is re-sized prior to contacting the lixiviant. Suitable raw materials include lime, dolomitic lime, steel slag, ash, fly ash, post-consumer waste, and/or mine tailings, and can be a sub-optimal source of the metal.

In some embodiments the insoluble metal carbonate is dried following collection. This can be accomplished by arranging the insoluble metal carbonate (e.g. by collection into heaps or piles) and exposing it to ambient environmental conditions. Alternatively or in addition, the insoluble metal carbonate can be placed in a kiln. In such embodiments the insoluble metal carbonate can be calcined to form a metal oxide.

Various sources of carbon dioxide are considered. For example a suitable source of carbon dioxide can include ambient, unmodified air from the atmosphere in an amount sufficient to provide at least about 100%, 80%, 70%, 60% 50%, 20%, or 10% of the carbon dioxide for the method. In some embodiments sources of carbon dioxide include flue gas, a fermentation byproduct, a biomass digestion product, a carbonate or carbonate solution, a bicarbonate or bicarbonate solution, and/or pure carbon dioxide. Carbon dioxide from such sources can be introduced by surface exposure, stirring, mixing, sparging, and/or percolation.

Another embodiment of the inventive concept is a method of reducing content of a greenhouse gas in atmospheric air by contacting a raw material (e.g. grade lime, dolomitic lime, steel slag, ash, fly ash, post-consumer waste, and mine tailings.) comprising a metal in the form of an insoluble metal salt or oxide with a lixiviant in a pond reactor to form a soluble metal salt and an extracted raw material, contacting the soluble metal salt with atmospheric air (e.g. by surface exposure, stirring, mixing sparging, and/or percolation) to form a purified metal salt and a regenerated lixiviant where the purified metal salt is essentially insoluble and comprises at least a portion of the greenhouse gas, and collecting purified metal salt. In such embodiments the greenhouse gas is carbon dioxide the purified metal salt is a carbonate or bicarbonate of the metal. Some embodiments include a step of separating the soluble metal salt from the extracted raw material, where at least a portion of separation of the soluble metal salt from the extracted raw material occurs prior to completion of formation of the soluble metal salt. Similarly, some embodiments of the inventive concept include a step of separating the purified metal salt from the regenerated lixiviant, where at least a portion of separation of the purified metal salt from the regenerated lixiviant occurs prior to completion of formation of the purified metal salt. Contacting the soluble metal salt with atmospheric air can occur over a period of from 1 day to 3 months.

The lixiviant can be present in substoichiometric quantities, stoichiometric quantities, or superstoichiometric quantities relative to content of the metal in the raw material. In preferred embodiments the lixiviant is an amine-based lixiviant. Contacting the raw material with the lixiviant can occur over a period of from 1 day to 3 months.

Some embodiments of the inventive concept include a step of drying the purified metal salt by exposure to ambient environmental conditions to form a dry purified metal salt. In such embodiments the dry purified metal salt can be treated in a kiln to form a calcined purified metal salt. Sequestering the purified metal salt, the dry purified metal salt, or the calcined purified metal salt effectively serves to remove the greenhouse gas from the atmosphere.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1: FIG. 1 provides a flowchart of a typical stepwise metal carbonate production process of the inventive concept.

FIG. 2: FIG. 2 provides a flowchart of a typical continuous metal carbonate production process of the inventive concept.

FIG. 3: FIG. 3 provides a flowchart of a typical continuous greenhouse gas reduction process of the inventive concept.

FIG. 4: FIG. 4 depicts a clarifier useful for separation steps in some embodiments of the inventive concept.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Embodiments of the inventive concept provide an inexpensive and scalable means to isolate commercially valuable metals from low quality raw materials with minimal capital expenditures. Metals are extracted from sized raw material using a lixiviant, such as an amine-based lixiviant, in a pond extractor. The liquid fraction containing solvated metal is separated from the extracted raw materials and exposed to an inexpensive and readily available source of carbon dioxide, such as unmodified atmospheric air and/or a flue gas. This precipitates the metal as a carbonate salt and regenerates the lixiviant, which is returned to the extraction step of the process following separation from the metal carbonates. Such methods can be used to reduce the content of greenhouse gases (such as CO₂) in atmospheric air through capture as an insoluble metal compound followed by sequestration of same. Metal carbonates can be dried by simply arranging in exposed heaps, and in some embodiments further processed by kiln drying.

Embodiments of the inventive process can include at least one compound of the general composition depicted in Compound 1 for use with any source of material that contains one or more form(s) of an alkaline earth (AE) hydroxide forming species, that can be hydrated to form AE(OH)x or other hydrated species that would react with lixiviants of the form found in Compound 1. Inventors, however, contemplate that any protic lixiviant having the general structure of HX where the molecule provides an H that has a pKa below 11 can be suitable. Alternatively, alkaline earth elements can be presented as oxides, for example calcium oxide (CaO), that can form hydroxides on reaction with water. Such hydrated forms may be present in the material as it is obtained from nature or can be introduced by processing (for example through treatment with a base, hydration, or by oxidation), and can be stable or transient. Selective extraction of the desired alkaline earth can be based on the presence of a metal hydroxide that has a stronger basicity than the organic amine-based lixiviants (or other non-amine lixiviant) used in the extraction process.

Organic amines of the inventive concept have the general formula shown in Compound 1, where N is nitrogen, H is hydrogen, and X is a counterion (i.e., a counter anion).

Ny,R₁,R₂,R₃,H—Xz Compound 1

Suitable counterions can be any form or combination of atoms or molecules that produce the effect of a negative charge. Counterions can be halides (for example fluoride, chloride, bromide, and iodide), anions derived from mineral acids (for example nitrate, phosphate, bisulfate, sulfate, silicates), anions derived from organic acids (for example carboxylate, citrate, malate, acetate, thioacetate, propionate and, lactate), organic molecules or biomolecules (for example acidic proteins or peptides, amino acids, nucleic acids, and fatty acids), and others (for example zwitterions and basic synthetic polymers). For example, monoethanolamine hydrochloride (MEA.HCl, HOC₂H₄NH₃Cl) conforms to Compound 1 as follows: one nitrogen atom (N₁) is bound to one carbon atom (R₁═C₂H₅O) and 3 hydrogen atoms (R₂, R₃ and H), and there is one chloride counteranion (X₁═Cl−). Compounds having the general formula shown in Compound 1 can have a wide range of acidities, and an organic amine of the inventive concept can be selected on the basis of its acidity so that it can selectively react with one or more alkaline earth metal salts or oxides from a sample containing a mixture of alkaline earth metal salts or oxides. Such a compound, when dissolved in water or another suitable solvent, can (for example) effectively extract the alkaline earth element calcium presented in the form calcium hydroxide in a suitable sample (e.g. steel slag). Equation 1 depicts a primary chemical reaction in extracting an insoluble alkaline earth (AE) salt (in this instance a hydroxide salt) from a matrix using an organic amine cation (OA-H+)/counterion (Cl−) complex (OA-H+/Cl−) as a lixiviant. Note that the OA-H+/Cl− complex dissociates in water into OA-H+ and Cl−.

AE(OH)₂(solid)+2 OA-H+(aq)+2 Cl-(aq)→AECl₂(aq)+2 OA (aq)+2 H₂O Equation 1

The counterion (Cl−) is transferred from the organic amine cation (OA-H+) to the alkaline earth salt to form a soluble alkaline earth/counterion complex (AECl₂), uncharged organic amine (OA), and water. Once solubilized the alkaline earth/counterion complex can be recovered from solution by any suitable means. For example, addition of a second counterion (SC) in an acid form (for example. H₂SC), which reacts with the alkaline earth cation/counterion complex to form an insoluble alkaline earth salt (AESC), can be used to precipitate the extracted alkaline earth from supernatant and release the counterion to regenerate the organic amine cation/counterion pair, as shown in Equation 2.

AECl₂(aq)+2 OA (aq)+H₂SC→AESC salt (solid)+2 OA+(aq)+2 Cl− Equation 2

Examples of suitable second counterions include polyvalent cations, for example carbonate (which can be supplied as CO₂), sulfate, sulfite, chromate, chlorite, and hydrogen phosphate.

Alternatively, pH changes, temperature changes, or evaporation can be used to precipitate the solubilized alkaline earth. In some embodiments, the alkaline earth element can be recovered by electrodeposition processes, such as electrowinning or electrorefining. In other embodiments of the inventive concept the solubilized alkaline earth element can be recovered by ion exchange, for example using a fixed bed reactor or a fluidized bed reactor with appropriate media.

A wide variety of ionic compounds are suitable for use as lixiviant species. For example, ammonium chloride, ammonium bromide, ammonium acetate, ammonium fluoride, ammonium propionate, ammonium lactate, ammonium nitrate, any combination of a strong acid and a weak base, any combination of any weak base and a weak acid, any combination of a strong base and weak acid, any combination of a strong base and a strong acid, naturally occurring or non-naturally occurring amino acids, and monoethanolamine hydrochloride are contemplated as suitable lixiviant species.

It should be appreciated that a variety of compounds are suitable for use as lixiviants in methods of the inventive concept, including carboxylic acids, ammonium salts, and organic compounds that incorporate one or more amine moieties (organic amines). Organic amines suitable for use as lixiviants can have a pKa of about 7 to about 14 or about 8 to about 14, and can include protonated ammonium salts (i.e., not quaternary). In preferred embodiments, the organic amines used to extract alkali metal elements are in a pKa range of about 8 to about 12. In more preferred embodiments, the organic amines used to extract alkali metal elements are in a pKa range of about 8.5 to about 11. In the even more preferred embodiments, the organic amines are in a pKa range of about 9 to about 10.5. Examples of suitable organic amines for use in lixiviants include weak bases such as ammonia, nitrogen containing organic compounds (for example monoethanolamine, diethanolamine, triethanolamine, morpholine, ethylene diamine, diethylenetriamine, triethylenetetramine, methylamine, ethylamine, propylamine, dipropylamines, butylamines, diaminopropane, triethylamine, dimethylamine, and trimethylamine), low molecular weight biological molecules (for example glucosamine, amino sugars, tetraethylenepentamine, amino acids, polyethyleneimine, spermidine, spermine, putrescine, cadaverine, hexamethylenediamine, tetraethylmethylenediamine, polyethyleneamine, cathine, isopropylamine, and a cationic lipid), biomolecule polymers (for example chitosan, polylysine, polyornithine, polyarginine, a cationic protein or peptide), and others (for example a dendritic polyamine, a polycationic polymeric or oligomeric material, and a cationic lipid-like material), or combinations of these. In some embodiments of the inventive concept the organic amine can be monoethanolamine, diethanolamine, or triethanolamine, which in cationic form can be paired with nitrate, bromide, chloride or acetate anions. In other embodiments of the inventive concept the organic amine can be lysine or glycine, which in cationic form can be paired with chloride or acetate anions. In a preferred embodiment of the inventive concept the organic amine is monoethanolamine, which in cationic form can be paired with a chlorine anion.

Such organic amines can range in purity from about 50% to about 100%. For example, an organic amine of the inventive concept can have a purity of about 50%, about 55%, about 60%, about 65%, about 70%, about 75%, about 80%, about 85%, about 90%, about 95%, about 97%, about 99%, or about 100%. In a preferred embodiment of the inventive concept the organic amine is supplied at a purity of about 90% to about 100%. It should be appreciated that organic amines can differ in their ability to interact with different metal oxides/hydroxides and with contaminating species, and that such selectivity can be utilized to provide highly selective recovery of a desired metal from a mixture present in a raw material.

Inventors further contemplate that zwitterionic species can be used in suitable lixiviants, and that such zwitterionic species can form cation/counterion pairs with two members of the same or of different molecular species. Examples include amine containing acids (for example amino acids and 3-aminopropanoic acid), chelating agents (for example ethylenediamine-tetraacetic acid and salts thereof, ethylene glycol tetraacetic acid and salts thereof, diethylene triamine pentaacetic acid and salts thereof, and 1,2-bis(o-aminophenoxy)ethane-N,N,N′,N′-tetraacetic acid and salts thereof), and others (for example betaines, ylides, and polyaminocarboxylic acids).

Organic amines for use in lixiviants can be selected to have minimal environmental impact. The use of biologically derived organic amines, such as glycine, is a sustainable practice and has the beneficial effect of making processes of the inventive concept more environmentally sound. In addition, it should be appreciated that some organic amines, such as monoethanol-amine, have a very low tendency to volatilize during processing. In some embodiments of the inventive concept an organic amine can be a low volatility organic amine (i.e., having a vapor pressure less than or equal to about 1% that of ammonia under process conditions). In preferred embodiments of the inventive concept, the organic amine is a non-volatile organic amine (i.e., having a vapor pressure less than or equal to about 0.1% that of ammonia under process conditions). Capture and control of such low volatility and non-volatile organic amines requires relatively little energy and can utilize simple equipment. This reduces the likelihood of such low volatility and non-volatile organic amines escaping into the atmosphere and advantageously reduces the environmental impact of their use.

Preferred organic amines can include: Methoxylamine hydrochloride solution, Ethanolamine ACS reagent, Ethanolamine, Ethanolamine hydrochloride, N-(Hydroxymethyl)acetamide, 2-(Methylamino)ethanol, 2-Methoxyethylamine, 3-Amino-1-propanol, Amino-2-propanol, DL-Alaninol, 3-Amino-1,2-propanediol, Serinol, 1,3-Diamino-2-propanol, N-(2-Hydroxyethyl)trifluoroacetamide, N-Acetylethanolamine technical grade, 1-Amino-2-methyl-2-propanol 95% anhydrous basis, 1-Methoxy-2-propylamine, 2-(Ethylamino)ethanol, 2-Amino-1-butanol, 2-Amino-2-methyl-1-propanol, 2-Dimethylaminoethanol, 3-Methoxypropylamine, 3-Methylamino-1-propanol, 4-Amino-1-butanol, 2-(2-Aminoethoxy)ethanol, 3-Methylamino-1,2-propanediol, Diethanolamine, Diethanolamine ACS reagent, Diethanolamine hydrochloride, Tris(hydroxymethyl)aminomethane ACS reagent, 2-(Ethylthio)ethylamine hydrochloride, 2,2′-Oxydiethylamine dihydrochloride, N-(2-Hydroxyethyl)ethylenediamine, meso-1,4-Diamino-2,3-butanediol dihydrochloride, Cystamine dihydrochloride, N-(3-Hydroxypropyl)trifluoroacetamide, trans-2-Aminocyclopentanol hydrochloride, 2-Methylaminomethyl-1,3-dioxolane, 1-Dimethylamino-2-propanol, 2-(Isopropylamino)ethanol, 2-(Propylamino)ethanol, 2-Amino-3-methyl-1-butanol, 3-Dimethylamino-1-propanol, 3-Ethoxypropylamine, 5-Amino-1-pentanol, DL-2-Amino-1-pentanol, 3-(Dimethylamino)-1,2-propanediol, N-Methyldiethanolamine, 2-(3-Aminopropylamino)ethanol, N-(4-Hydroxybutyl)trifluoroacetamide, 1-Amino-1-cyclopentanemethanol, trans-2-Aminocyclohexanol hydrochloride, trans-4-Aminocyclohexanol hydrochloride, 2-(Butylamino)ethanol, 2-(Diethylamino)ethanol, 2-(tert-Butylamino)ethanol, 2-Dimethylamino-2-methylpropanol, 4-(Dimethylamino)-1-butanol, 6-Amino-1-hexanol, DL-2-Amino-1-hexanol, Bis(2-hydroxypropyl)amine, Bis(2-methoxyethyl)amine, N-Ethyldiethanolamine, Triethanolamine reagent grade, L-Leucinol hydrochloride, N,N′-Bis(2-hydroxyethyl)ethylenediamine, 5-Amino-2-chlorobenzyl alcohol, 2-Aminobenzyl alcohol, 3-Aminobenzyl alcohol, 4-Aminobenzyl alcohol, 2-Amino-4-methoxyphenol, 3,4-Dihydroxybenzylamine hydrobromide, 3,5-Diaminobenzyl alcohol dihydrochloride, N-(5-Hydroxypentyl)trifluoroacetamide, 3-(Allyloxycarbonylamino)-1-propanol, 1-Aminomethyl-1-cyclohexanol hydrochloride, trans-2-(Aminomethyl)cyclohexanol hydrochloride, N-Boc-ethanolamine, 3-Butoxypropylamine, 3-Diethylamino-1-propanol, 5-Amino-2,2-dimethylpentanol, 3-(Diethylamino)-1,2-propanediol, 1,3-Bis(dimethylamino)-2-propanol, 2-{[2-(Dimethylamino)ethyl]methylamino}ethanol, 4-Chloro-N-(2-hydroxyethyl)-2-nitroaniline, 2-Amino-1-phenylethanol, 2-Amino-3-methylbenzyl alcohol, 2-Amino-5-methylbenzyl alcohol, 2-Aminophenethyl alcohol, 3-Amino-2-methylbenzyl alcohol, 3-Amino-4-methylbenzyl alcohol, 4-(1-Hydroxyethyl)aniline, 4-Aminophenethyl alcohol, N-(2-Hydroxyethyl)aniline, 3-Hydroxy-4-methoxybenzylamine hydrochloride, 3-Hydroxytyramine hydrobromide, 4-Hydroxy-3-methoxybenzylamine hydrochloride, Norphenylephrine hydrochloride, 5-Hydroxydopamine hydrochloride, 6-Hydroxydopamine hydrobromide, DL-Norepinephrine hydrochloride crystalline, N-(6-Hydroxyhexyl)trifluoroacetamide, 4-Diethylamino-2-butyn-1-ol, Tropine, 3-(Boc-amino)-1-propanol, N-Boc-DL-2-amino-1-propanol, N-Boc-serinol, 2-(Diisopropylamino)ethanol, N-Butyldiethanolamine, N-tert-Butyldiethanolamine, DL-4-Chlorophenylalaninol, 2-(Methylphenylamino)ethanol, 2-Benzylaminoethanol, 3-(Dimethylamino)benzyl alcohol, α-(Methylaminomethyl)benzyl alcohol, 4-(B oc-amino)-1-butanol, N-Boc-DL-2-amino-1-butanol, N-Boc-2-amino-2-methyl-1-propanol, N-Z-Ethanolamine, 2-[4-(Dimethylamino)phenyl]ethanol, 2-(N-Ethylanilino)ethanol, α-[2-(Methylamino)ethyl]benzyl alcohol, Ephedrine hydrochloride, N-Benzyl-N-methylethanolamine, 3,5-Dimethoxyphenethylamine, N-Phenyldiethanolamine, Metanephrine hydrochloride, 3-Amino-1-adamantanol, 6-(Allyloxycarbonylamino)-1-hexanol, 5-(Boc-amino)-1-pentanol, N-Boc-DL-2-amino-1-pentanol, 2-(Dibutylamino)ethanol, Benzyl N-(3-hydroxypropyl)carbamate, N-Boc-4-hydroxyaniline, N-(Benzyloxycarbonyl)-3-amino-1,2-propanediol, 2-(N-Ethyl-N-m-toluidino)ethanol, 2,2′-(4-Methylphenylimino)diethanol, N4-Ethyl-N4-(2-hydroxyethyl)-2-methyl-1,4-phenylenediamine sulfate salt, N-Boc-1-amino-1-cyclopentanemethanol, Choline dihydrogen citrate salt, 6-(Boc-amino)-1-hexanol, N-Boc-DL-2-amino-1-hexanol, 4-(Z-Amino)-1-butanol, 2,2′-[4-(2-Hydroxyethylamino)-3-nitrophenylimino]diethanol, 5-(Z-Amino)-1-pentanol, 4-Acetylamino-2-(bis(2-hydroxyethyl)amino)anisole, 3-[Bis(2-hydroxyethyl)amino]propyl-triethoxysilane solution technical, 4-(Z-amino)cyclohexanol, Oxolamine citrate salt, 6-(Z-Amino)-1-hexanol, 2,2-Bis(3-amino-4-hydroxyphenyl)hexafluoropropane, Tris[2-(2-methoxyethoxy)ethyl]amine, 8-Hydroxy-2-(dipropylamino)tetralin hydrobromide, 2-(Fmoc-amino)ethanol, 3-(Dibenzylamino)-1-propanol, 3-(Fmoc-amino)-1-propanol, 4-(Fmoc-amino)-1-butanol, 2-[2-(Fmoc-amino)ethoxy]ethanol, 5-(Fmoc-amino)-1-pentanol, 6-(Fmoc-amino)-1-hexanol, trans-2-(Fmoc-aminomethyl)cyclohexanol, N,N-Bis[2-(p-tolylsulfonyloxy)ethyl]-p-toluenesulfonamide, and (Hydroxymethyl)benzoguanamine, methylated/ethylated.

Preferred organic amines can also include polymer-based amines and salts including, for example, polyetheneimine hydrochloride. Preferred organic amines can also include mixtures of polyamines and/or polyacids and amines, including, for example, polyacrylic acid and ammonia.

Inorganic amines can also be selected for use in lixiviants. Inorganic amines, or azanes, are inorganic nitrogen compounds with the general formula NR₁R₂R₃. Inorganic amines can include ammonia, ammonia borane, ammonium chloride, ammonium acetate, ammonium nitrate, ammonium bromide, chloramine, dichloramine, hydroxylamine, nitrogen tribromide, nitrogen trichloride, nitrogen trifluoride, and nitrogen triiodide. In some embodiments of the inventive concept, an inorganic amine with low vapor pressure relative to other inorganic amines can be used to prevent the off-gassing of inorganic amines.

In a preferred embodiment of the inventive concept, the alkaline earth element can be recovered by precipitation through reaction of the mixture with carbon dioxide (CO₂), which advantageously regenerates the lixiviant as shown below. It should be appreciated that the process of recovering the alkaline earth element can be selective, and that such selectivity can be utilized in the recovery of multiple alkaline earth elements from a single source as described below.

The organic amine cation/counterion complex can be produced from the uncharged organic amine to regenerate the OA-H+/Cl− lixiviant, for example using an acid form of the counterion (H—Cl), as shown in Equation 3.

OA (aq)+H—Cl(aq)→OA-H+(aq)+Cl− Equation 3

In some embodiments of the inventive concept the reaction described in Equation 3 can be performed after the introduction of an uncharged organic amine to a source of an alkaline earth element, with the lixiviant being generated afterwards by the addition of an acid form of the counterion. This advantageously permits thorough mixing of the alkaline earth source with a lixiviant precursor prior to initiating the reaction.

Organic amines suitable for the extraction of alkaline earth elements (for example from calcium containing or, steel slag, and other materials) can have a pKa of about 7 or about 8 to about 14, and can include protonated ammonium salts (i.e., not quaternary). Examples of suitable organic amines for use in lixiviants include weak bases such as ammonia, nitrogen containing organic compounds (for example monoethanolamine, diethanolamine, triethanolamine, morpholine, ethylene diamine, diethylenetriamine, triethylenetetramine, methylamine, ethylamine, propylamine, dipropylamines, butylamines, diaminopropane, triethylamine, dimethylamine, and trimethylamine), low molecular weight biological molecules (for example glucosamine, amino sugars, tetraethylenepentamine, amino acids, polyethyleneimine, spermidine, spermine, putrescine, cadaverine, hexamethylenediamine, tetraethylmethylenediamine, polyethyleneamine, cathine, isopropylamine, and a cationic lipid), biomolecule polymers (for example chitosan, polylysine, polyornithine, polyarginine, a cationic protein or peptide), and others (for example a dendritic polyamine, a polycationic polymeric or oligomeric material, and a cationic lipid-like material), or combinations of these. In some embodiments of the inventive concept the organic amine can be monoethanolamine, diethanolamine, or triethanolamine, which in cationic form can be paired with nitrate, bromide, chloride or acetate anions. In other embodiments of the inventive concept the organic amine can be lysine or glycine, which in cationic form can be paired with chloride or acetate anions. In a preferred embodiment of the inventive concept the organic amine is monoethanolamine, which in cationic form can be paired with a chlorine anion.

Such organic amines can range in purity from about 50% to about 100%. For example, an organic amine of the inventive concept can have a purity of about 50%, about 55%, about 60%, about 65%, about 70%, about 75%, about 80%, about 85%, about 90%, about 95%, about 97%, about 99%, or about 100%. In a preferred embodiment of the inventive concept the organic amine is supplied at a purity of about 90% to about 100%. It should be appreciated that organic amines can differ in their ability to interact with different members of the alkaline earth family and with contaminating species, and that such selectivity can be utilized in the recovery of multiple alkaline earths as described below.

Inventors further contemplate that zwitterionic species can be used in suitable lixiviants, and that such zwitterionic species can form cation/counterion pairs with two members of the same or of different molecular species. Examples include amine containing acids (for example amino acids and 3-aminopropanoic acid), chelating agents (for example ethylenediamine-tetraacetic acid and salts thereof, ethylene glycol tetraacetic acid and salts thereof, diethylene triamine pentaacetic acid and salts thereof, and 1,2-bis(o-aminophenoxy)ethane-N,N,N′,N′-tetraacetic acid and salts thereof), and others (for example betaines, ylides, and polyaminocarboxylic acids).

Organic amines for use in lixiviants can be selected to have minimal environmental impact. The use of biologically derived organic amines, such as glycine, is a sustainable practice and has the beneficial effect of making processes of the inventive concept more environmentally sound. In addition, it should be appreciated that some organic amines, such as monoethanol-amine, have a very low tendency to volatilize during processing. In some embodiments of the inventive concept an organic amine can be a low volatility organic amine (i.e., having a vapor pressure less than or equal to about 1% that of ammonia under process conditions). In preferred embodiments of the inventive concept the organic amine is a non-volatile organic amine (i.e., having a vapor pressure less than or equal to about 0.1% that of ammonia under process conditions). Capture and control of such low volatility and non-volatile organic amines requires relatively little energy and can utilize simple equipment. This reduces the likelihood of such low volatility and non-volatile organic amines escaping into the atmosphere and advantageously reduces the environmental impact of their use.

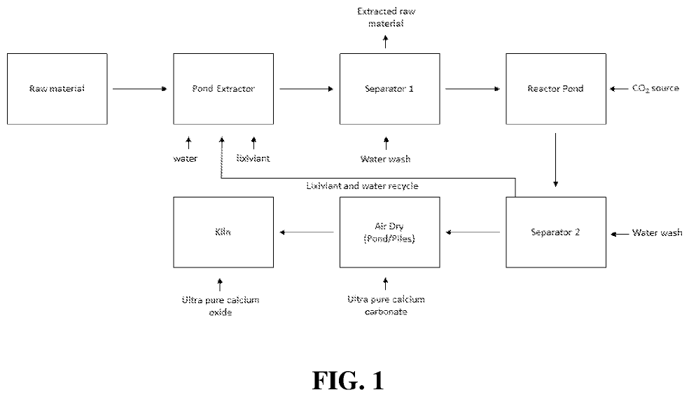

The inventive subject matter provides apparatus, systems and methods for recovery of metals from low quality ores (such as lime and/or dolomitic lime), industrial waste materials (e.g. steel slag, ash, and/or fly ash), post-consumer waste, and/or mine tailings. A flow diagram of an exemplary stepwise or discontinuous process is shown in FIG. 1. Such materials can be used as-is or sized (for example, by crushing or grinding) to generate a crushed raw material that is introduced to a pond extractor. Such a pond extractor can be an open body of water, which in some embodiments can be lined and/or covered to prevent or reduce loss of liquid contents. An amine-based lixiviant (e.g. ethanolamine, ammonium salts, etc.) is introduced, resulting in solvation of the desired metal from the crushed raw material into the aqueous phase of the pond extractor.

In some embodiments the amine-based lixiviant is provided in sub-stoichiometric quantities relative to the expected metal content of the crushed raw material. When such sub-stoichiometric amounts are used the contact time with the raw material can be relatively long compared to prior art methods. In some embodiments this contact time can be one or more days, weeks, or months. In preferred embodiments the contact time can range from 1 hour to up to three months. Alternatively, superstoichiometric amounts of lixiviant (relative to the expected metal content of the raw material) can be used. Such superstoichiometric amounts of lixiviant can, when used in combination with sufficient carbon dioxide, provide relatively short contact times relative to processes where stoichiometric and/or substoichiometric amounts of lixiviant are used.

After allowing time for solvation of the desired metal the aqueous pond contents are separated from the extracted raw material. For example, when lime is used as a raw material the extracted raw material can be primarily silica. It should be appreciated that such extracted raw materials are relatively enriched in unextracted metals following the extraction process, and can be used as sources of such unextracted metals in subsequent processes. Separation can be performed by any suitable means, including settling and decantation, use of a cyclone or other centrifugal separator, or use of a filter. Separation can be performed at the completion of metal solvation, at one or more times prior to the completion of metal solvation (with return of partially treated raw materials to the pond extractor) or can be performed on an essentially continuous basis (with return of partially treated raw materials to the pond extractor).

The separated aqueous pond contents, which include the solvated metal, are transferred to a reactor or reactor pond, where CO₂ is introduced to generate a metal carbonate (while simultaneously regenerating the lixiviant). CO₂ can be supplied by a variety of sources, which can vary widely in CO₂ content. Suitable sources include untreated/atmospheric air, flue gases, gaseous waste products from fermentation and/or biomass digestion, purified (e.g. greater than 80%) CO₂ gas, and/or carbonate/bicarbonate salts.

Sources of CO₂ can be applied by any suitable means. For example, in some embodiments simple surface exposure to untreated/atmospheric air as a source of CO₂ can be sufficient, particularly when coupled with periodic or constant mixing and/or agitation of the liquid mass. Alternatively, gaseous sources of CO₂ (such as untreated/atmospheric air, flue gas, fermentation product, etc.) can be introduced directly into the water column (for example by release at the bottom of the pond or at an intermediate depth), for example by sparging. In such embodiments one or more diffusers or similar gas distribution devices can be employed. In other embodiments can be supplied as a liquid (for example a CO₂, bicarbonate, or carbonate solution) that is mixed with pond contents. In still other embodiments CO₂ can be supplied as a solid (e.g., solid bicarbonate and/or carbonate salts) that distributed across the pond surface and allowed to dissolve.

As noted above CO₂ content can impact the kinetics of the metal recovery process. Untreated/atmospheric air can serve as a source with relatively low content, whereas purified gas can provide high content with faster kinetics. In a preferred embodiments CO₂ is provided by mixing untreated/atmospheric air as the primary (i.e. greater than 80%) or sole source of CO₂. In some embodiments untreated/atmospheric air can provide 10%, 20%, 30%, 40%, 50%, 60% 70%, 80%, 90% 95%, of more than 95% of the CO₂ used in the method of the inventive concept. Due to the relatively low CO₂ content of unmodified air the reaction is slow relative to conventional processes. As a result this period of carbonate generation/lixiviant regeneration can take place over one or more days, weeks, or months. In some embodiments the time over which this step is performed can range from 1 day to up to three months, or more than three months. The extended time required is offset, however, by the cost savings provided through the use of untreated/atmospheric air.

Metal carbonates can be separated from the liquid contents of such a reactor or pond reactor by any suitable means. For example, metal carbonates can be separated by settling and decanting, filtration, and/or the use of a centrifugal separator. Separation can be performed at the completion of carbonate formation, at one or more times prior to the completion of carbonate formation, or can be performed on an essentially continuous basis. Following initial separation the resulting metal carbonate solid can be washed by the addition of fresh water one or more times. Separated liquid contents, which include regenerated lixiviant, and washings can be transferred to the pond reactor, effectively recycling the lixiviant and reducing water consumption.

Following separation and washing metal carbonates can be allowed to dry, for example by arrangement in loose, exposed piles. The resulting ultra-pure metal carbonates can be used as-is at this point, or transferred to a kiln for further processing (e.g. calcination to form CaO).

In some embodiments the extracted raw material recovered following treatment with the lixiviant can be processed further in order to recovery additional valuable materials, which are relatively more abundant following extraction of calcium. For example, such extracted raw material can be contacted with a second lixiviant having a different specificity for solvating insoluble metal salts or oxides in order to extract one or more additional metals.

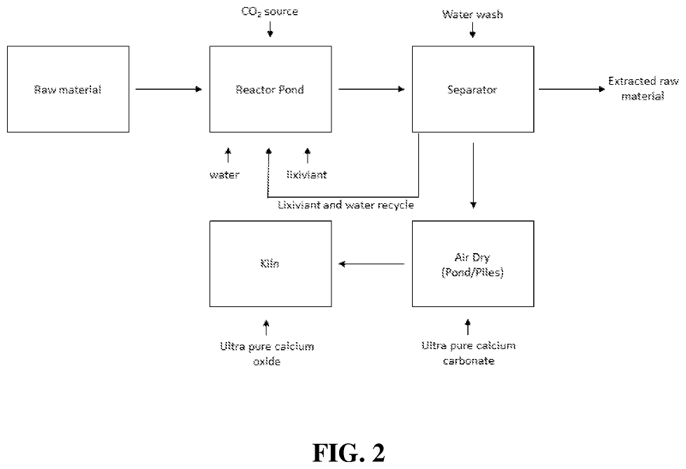

It should be appreciated that, while FIG. 1 depicts a stepwise, discontinuous process the Applicant contemplates that the filtration steps depicted can be performed prior to completion of the metal solvation or carbonate formation reactions of the preceding steps. When performed in such a manner the process depicted in FIG. 1 can be adapted to provide an at least partially continuous process for metal extraction. An example of such a continuous process is shown in FIG. 2.

As shown, a raw material containing an insoluble salt or oxide of a desired metal is introduced to a pond reactor and contacted with a lixiviant and a source of CO₂ (such as untreated/atmospheric air). As described above, reaction with the lixiviant results in solvation of the desired metal and release into the aqueous milieu of the pond. Contact with the source of CO₂ results in both the precipitation of the desired metal as a carbonate and the regeneration of the lixiviant species. A separator (such as a centrifugal separator or cyclone separator) can be used to separate the extracted raw material from the metal carbonate precipitate and from the water/lixiviant mixture. The water/lixiviant mixture can be recycled to the reactor pond for reaction with additional raw material, while the metal carbonate can be transferred to an area for drying. The extracted raw material can be recovered and, as noted above, further processed in order to recover additional valuable materials. Optionally, recovered solids (i.e. metal carbonate, extracted raw material) can be washed and the washings returned to the reactor pond. Such a method can, advantageously, be operated continuously with minor replenishment of lixiviant.

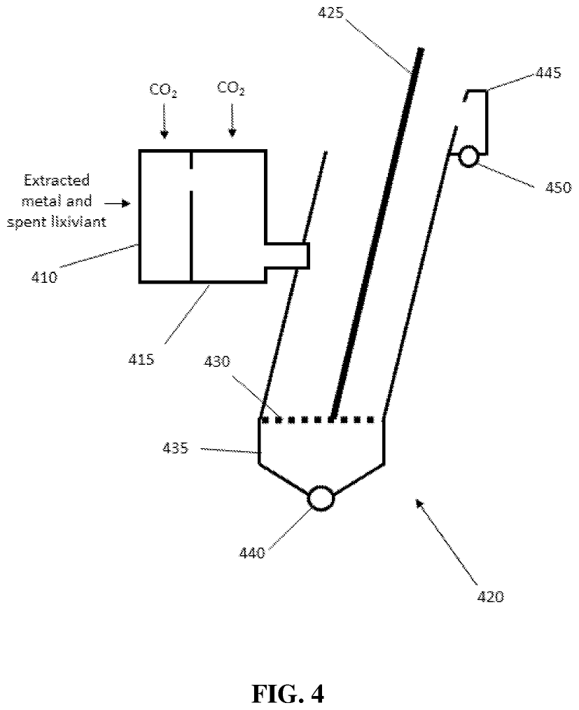

As noted above, a variety of technologies for separation of solids from liquids can be utilized in methods of the inventive concept. In a preferred embodiment at least a portion of the separation steps can be performed by clarification, which can be performed using a clarifier. An example of a system incorporating a clarifier is provided in FIG. 4, which as shown is applied to the liquid fraction containing the solubilized metal following extraction from the raw material (e.g. the liquid portion of a suspension produced in the pond extractor depicted in FIG. 1). As shown, such an arrangement can include a rapid mixing portion 410 that is in fluid communication with a flocculation portion 415. In some embodiments a liquid fraction containing the solubilized metal of interest is initially added to the rapid mixing portion 410 along with a source of CO₂ (e.g. ambient, unmodified air). The rapid mixing portion can include a stirring device (such as a rotating blade or paddle). Precipitation started in the rapid mixing portion 410 can continue in the flocculation portion 415, and the suspension of flocculant precipitate transferred to the clarifier 420. In preferred embodiments of the inventive concept the rapid mixing portion, the flocculation portion, or both can be provided in the form of reaction ponds.

On introduction to the clarifier 420 the suspension of precipitated metal salt initially encounters a separation plate 425 that directs flow towards a grating 430. The grating 430 leads to a pyramid hopper 435, which is configured to reduce the flow rate and collect solids in its lower portion through settling. These solids (e.g. precipitate metal salts) can be collected through a solids port 440. The remaining liquid portion or supernatant is guided upwards by the separation plate 425 and spills over into a supernatant trough 445, where it can be collected through a liquids port 450. This liquid portion can include regenerated lixiviant, which can be returned to initial steps of the overall process for extraction of additional raw materials.

It should be appreciated that one or more such clarifiers can be utilized as separators in the process shown in FIG. 1. For example, a clarifier can be utilized for separation of extracted raw material that is in suspension with a liquid portion containing extracted metal and expended lixiviant, as generated in the pond extractor. Similarly, a second clarifier can used to separate the suspension of precipitated insoluble metal salt and regenerated lixiviant produced in the reactor pond. The regenerated lixiviant recovered from the second clarifier can then be returned to the pond extractor.

One should appreciate that the disclosed techniques provide many advantageous technical effects including economical isolation of commercially valuable metals from low quality raw materials, using scalable methods that have minimal environmental impact.

Processes of the inventive concept can be used for the isolation of a wide variety of metals, for example through the selection of lixiviant species. In preferred embodiments of the inventive concept the metal is an alkaline earth metal, such as calcium and/or magnesium. Other metal species, including rare earths and transition metals, are also contemplated.

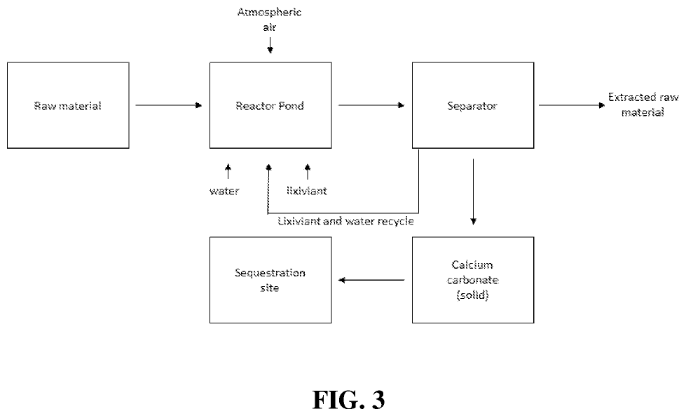

Another embodiment of the inventive concept is a method for reducing the content of a greenhouse gas (e.g. CO₂) in atmospheric air. As described above, unmodified/atmospheric air is useful as a source of CO₂ in reactions that can generate a stream of solid carbonates from low quality sources such lime, dolomite lime, and various industrial wastes. Such reactions capture atmospheric CO₂ (e.g. approximately 1.1 tons for every ton of reactive calcium) in a form that can be utilized for commercial purposes or easily sequestered. An example of such a continuous embodiment of such a method is shown in FIG. 3. As shown, a raw material that includes a reactive metal in the form of an insoluble salt or oxide is introduced into a reactor pond, which contains a lixiviant as described above. The pond is contacted with the atmosphere, and CO₂ content of the atmosphere subsequently captured as solid carbonate salts, while simultaneously regenerating the lixiviant. Such contact can be by simple surface exposure, which can be enhanced by mixing and/or stirring. Alternatively, air can be actively introduced through sparging. A separator (such as a centrifugal separator or cyclone separator) can be used to separate the extracted raw material and the solid carbonate from each other and from the liquid fraction that contains the lixiviant. The liquid fraction can be returned to the reactor pond for extraction of additional CO₂. The resulting metal carbonate, containing CO₂ captured from the atmosphere, can be used for a wide variety of commercial purposes or sequestered in order to prevent return of the captured CO₂ to the atmosphere. In some embodiments extracted raw materials can be further processed to recover valuable metals.

While alkaline earth metals (e.g. calcium) are cited above, embodiments of the inventive concept can provide recovery of other metals that are present as insoluble salts and oxides in suitable raw materials. In some embodiments such metals include one or more Group 11 elements, such as copper, silver, and gold. In other embodiments such metals include one or more rare earth elements, such as cerium, dysprosium, erbium, europium, gadolinium, holmium, lanthanum, lutetium, neodymium, praseodymium, promethium, samarium, scandium, terbium, thulium, yterrbium, and yttrium.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1-40. (canceled)

41. A method of isolating a metal comprising:
contacting a raw material comprising the metal with a lixiviant in a first reactor to form a soluble metal salt and an extracted raw material;
separating the soluble metal salt from the extracted raw material;
contacting the soluble metal salt with a source of carbon dioxide in a second reactor to form an insoluble metal carbonate and a regenerated lixiviant;
separating the insoluble metal carbonate from the regenerated lixiviant;
returning the regenerated lixiviant to the first reactor; and
collecting the insoluble metal carbonate,
wherein unmodified air is the primary source of carbon dioxide utilized in formation of the insoluble metal carbonate.

42. The method of claim 41, wherein the first reactor is configured as a first pond reactor and the second reactor is configured as a second pond reactor.

43. The method of claim 41, wherein at least a portion of separation of the soluble metal salt from the extracted raw material occurs prior to completion of formation of the soluble metal salt.

44. The method of claim 41, wherein at least a portion of separation of the insoluble metal carbonate from the regenerated lixiviant occurs prior to completion of formation of the insoluble metal carbonate.

45. The method of claim 41, wherein the lixiviant is present in substoichiometric quantities relative to the metal of the raw material.

46. The method of claim 41, wherein the lixiviant is present in stoichiometric quantities relative to the metal of the raw material.

47. The method of claim 41, wherein the raw material comprises a sub-optimal source of the metal.

48. The method of claim 41, wherein the source of carbon dioxide is selected from the group consisting of unmodified ambient air, a flue gas, a fermentation byproduct, a biomass digestion product, a carbonate or carbonate solution, a bicarbonate or bicarbonate solution, and pure carbon dioxide.

49. The method of claim 41, wherein the source of carbon dioxide is introduced to the second reactor by one or more of surface exposure, stirring, mixing, sparging, and percolation.

50. The method of claim 41, comprising the step of calcining the insoluble metal carbonate to generate a metal oxide.

51. A method of reducing content of a greenhouse gas in atmospheric air, comprising:
contacting a raw material comprising a metal in the form of an insoluble metal salt or oxide with a lixiviant in a pond reactor to form a soluble metal salt and an extracted raw material;
contacting the soluble metal salt with atmospheric air to form a purified metal salt and a regenerated lixiviant, wherein the purified metal salt is essentially insoluble and comprises at least a portion of the greenhouse gas; and
collecting a purified metal salt,
wherein the greenhouse gas is carbon dioxide and the purified metal salt is a carbonate or bicarbonate of the metal.

52. The method of claim 51, comprising a step of separating the soluble metal salt from the extracted raw material, and wherein at least a portion of separation of the soluble metal salt from the extracted raw material occurs prior to completion of formation of the soluble metal salt.

53. The method of claim 51, comprising a step of separating the purified metal salt from the regenerated lixiviant, wherein at least a portion of separation of the purified metal salt from the regenerated lixiviant occurs prior to completion of formation of the purified metal salt.

54. The method of claim 51, wherein the lixiviant is present in substoichiometric quantities relative to content of the metal in the raw material.

55. The method of claim 51, wherein the lixiviant is an amine-based lixiviant.

56. The method of claim 51, wherein the raw material is selected from the group consisting of low grade lime, dolomitic lime, steel slag, ash, fly ash, post-consumer waste, and mine tailings.

57. The method of claim 51, comprising drying the purified metal salt by exposure to ambient environmental conditions to form a dry purified metal salt.

58. The method of claim 51, comprising sequestering the purified metal salt, the dry purified metal salt, or the calcined purified metal salt.

59. The method of claim 51, wherein atmospheric air is introduced contacted with the soluble metal salt by one or more of surface exposure, stirring, mixing, sparging, and percolation.

60. The method of claim 51, comprising the step of calcining the insoluble metal carbonate to generate a metal oxide.
